(19) United States
(12) Patent Application Publication
(10) Pub. No.: US 2013/0049700 A1
(43) Pub. Date: Feb. 28, 2013

(54) Method and apparatus for timed electrical application

(71) Applicant: Madhavan Pisharodi, Brownsville, TX (US)

(72) Inventor: Madhavan Pisharodi, Brownsville, TX (US)

(21) Appl. No.: 13/199,429

(22) Filed: Aug. 30, 2011

(51) Int. Cl. H02J 7/04; H01R 13/66

(52) U.S. Cl. 320/148; 439/620.21

(57) ABSTRACT

Apparatus for disconnecting a charger or a device incorporating a charger for a rechargeable battery from the power source either after charging is complete or after a pre-set time interval to minimize damage to the battery. The apparatus includes a plug in an enclosure for plugging into a power source or other power outlet, the enclosure being provided with an outlet for receiving a power cable from the battery charger or the device including the rechargeable battery. Circuitry is provided in the enclosure for switching off the power supplied to the charger or the device including the battery upon receipt of a signal from the device or after a pre-set time interval has elapsed.

### BACKGROUND OF THE INVENTION

The present invention is a process, and an apparatus, for controlling the application of electrical power to an electrically-operated device, particularly intended, but not limited to, a device for charging a rechargeable battery such as a radio or cell phone battery.

On information and belief, almost every type of rechargeable battery (lead-acid, nickel-cadmium, nickel-metal hydride, lithium, etc.) can be damaged and/or its operating capacity can be reduced by what is often referred to as overcharging. Many such devices, the chargers for such batteries, and sometimes even the batteries themselves, are provided with indicator lights or other alerts to inform the user that the battery is charged, the intention being that the device or battery should be removed from the charger once charging is complete. Further, the instruction manuals of almost every such device include warnings, sometimes even prominent warnings, that the device not be overcharged and that it should be removed from the charger or power source when the charge indicator appears.

In actual practice, however, the users of devices that are powered by rechargeable batteries tend to leave the battery, or the device including the battery, on the charger or connected to a power source from the time charging starts until the device or battery is unplugged for subsequent use. As a result, the battery is often left on the charger and/or the device including the battery stays connected to a power source for many hours longer than needed to recharge the battery (newly-developed battery technology has produced batteries that charge in minutes rather than hours with the result that the battery and/or device stays on the charger far longer than necessary) despite the prominent warnings against overcharging. It is, therefore, an object of the present invention to provide an apparatus and method for switching off the power from an electrical source that is provided to a rechargeable battery, or a device incorporating a rechargeable battery, from its charger or power source either after a specified period of time or upon detection of an indicator produced by the charger, the battery, or the device when the battery is charged.

It is also an object of the present invention to provide an apparatus in which battery charging time can be selected by the user.

Another object of the present invention is to provide an apparatus that is small enough that it can be conveniently transported by the user and that is easy enough to use that its use is not discouraged by unnecessary complication.

Another object of the present invention is to provide an apparatus for switching off the electrical power applied to a device such as a battery charger that is easily adapted for use with different power sources and/or different voltages or types of current for mobile uses and in multiple locations.

Other objects, and the many advantages of the present invention, will be made clear to those skilled in the art in the following detailed description of the preferred embodiment(s) of the invention and the drawings appended hereto. Those skilled in the art will recognize, however, that the embodiment(s) of the present invention that are described herein are only examples of specific embodiment(s) of methods and apparatus for switching off the electrical power applied to an electrically-powered device such as a battery charger, set out for the purpose of describing the making and using of the present invention, and that the embodiment(s) shown and/or described herein are not the only embodiment(s) of and method constructed and/or performed in accordance with the teachings of the present invention.

### SUMMARY OF THE INVENTION

The present invention is an apparatus for interrupting the charging of either a rechargeable battery, a device including a rechargeable battery, or a charger for a rechargeable battery comprising a plug for connecting to a power source, an outlet for receiving a plug from either a rechargeable battery, a device including a rechargeable battery, or a charger for a rechargeable battery, and circuitry for switching off the power provided to the outlet either after a period of time specified by the user or upon detection of an indicator output from the batter, the charger for the battery, or the device including the battery.

In another aspect, a method of interrupting the power provided to either a rechargeable battery, a device including a rechargeable battery, or a charger for a rechargeable battery is provided. The method comprises the steps of connecting either a rechargeable battery, a device including a rechargeable battery, or a charger for a rechargeable battery to a power source, charging the battery; and detecting a signal output by the battery, the device including the battery, or the charger indicating that the battery is charged, and switching the power provided to the battery, the device including the battery, or the charger off.

### BRIEF DESCRIPTION OF THE DRAWINGS

Referring now to the figures, FIGS. 1A-1T are respective top, side, end, and perspective views of several presently preferred embodiments of an apparatus including a timer for switching off the power to an electrically-operated device constructed in accordance with the present invention.

FIG. 2 is a schematic view of the circuitry of the apparatus of FIGS. 1A-1D.

### DETAILED DESCRIPTION OF THE PREFERRED EMBODIMENT(S)

Referring to FIG. 1, there is shown an apparatus constructed in accordance with the teachings of the present invention comprising an enclosure 10 having a standard three-prong (grounded) plug 12 incorporated therein that is plugged by the user into a standard 120V AC power outlet. Although illustrated as being adapted for plugging into a 120V AC outlet, those skilled in the art will recognize that the enclosure 10 may also be adapted for plugging into other types of power outlets such as a 12V DC automotive power outlet and/or into a USB port (for devices that are charged by connection to the powered USB port of a computer), or that it may be manufactured with multiple plugs and internal circuitry as known in the art so that it is capable of being plugged into more than one type of power outlet such that the particular enclosure shown herein should not be construed as limiting the invention to any particular type of power source or plug.

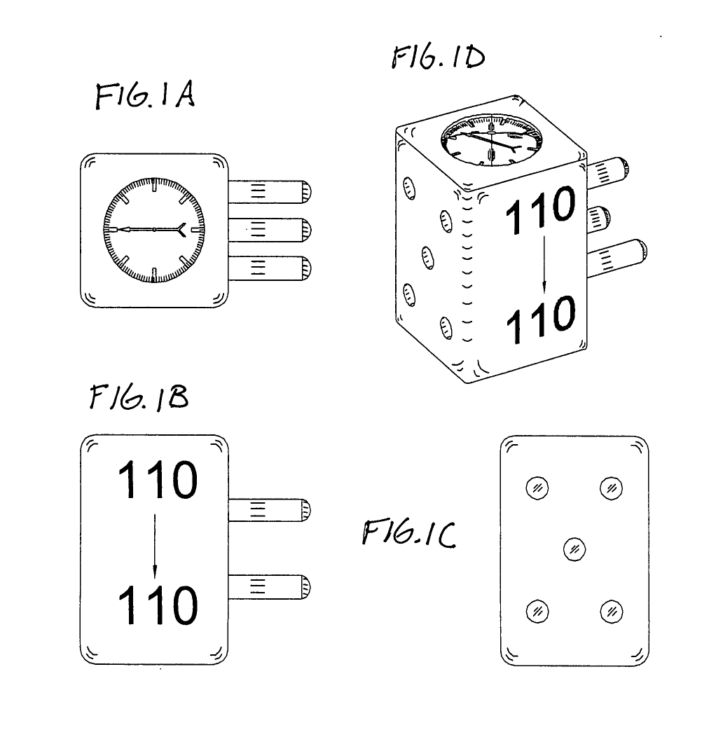

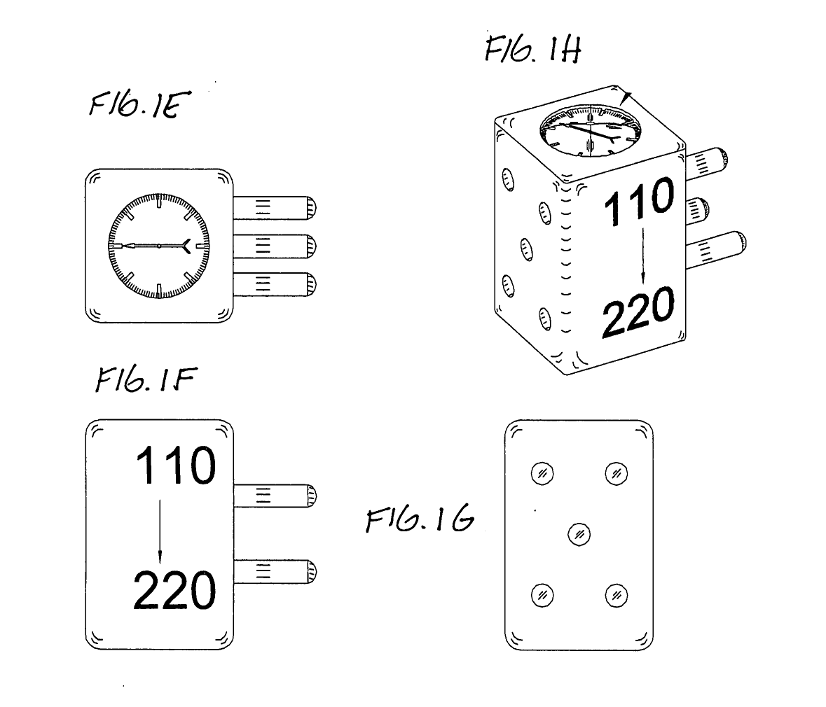

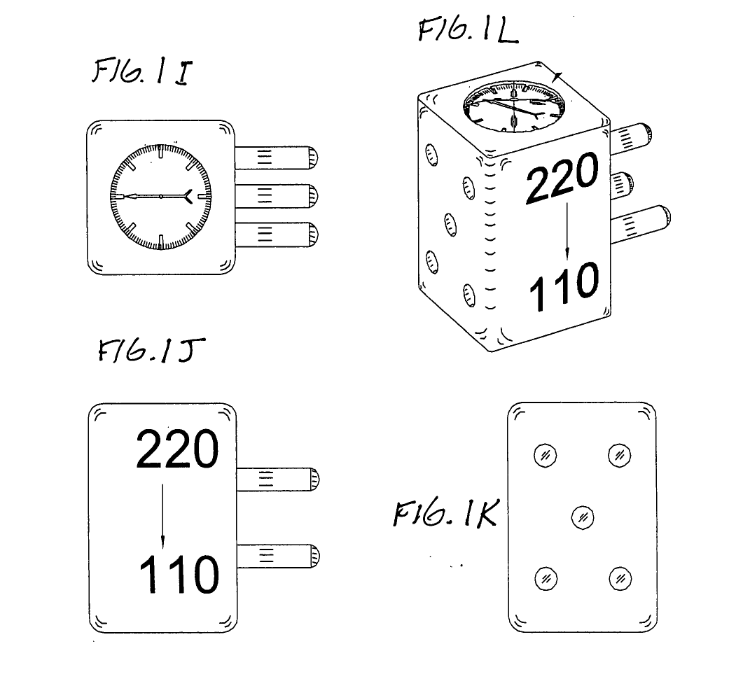

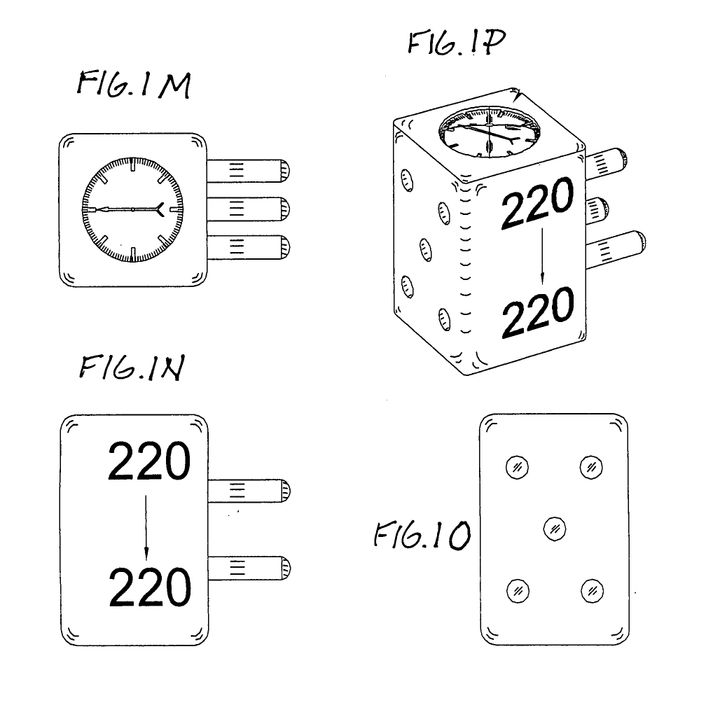

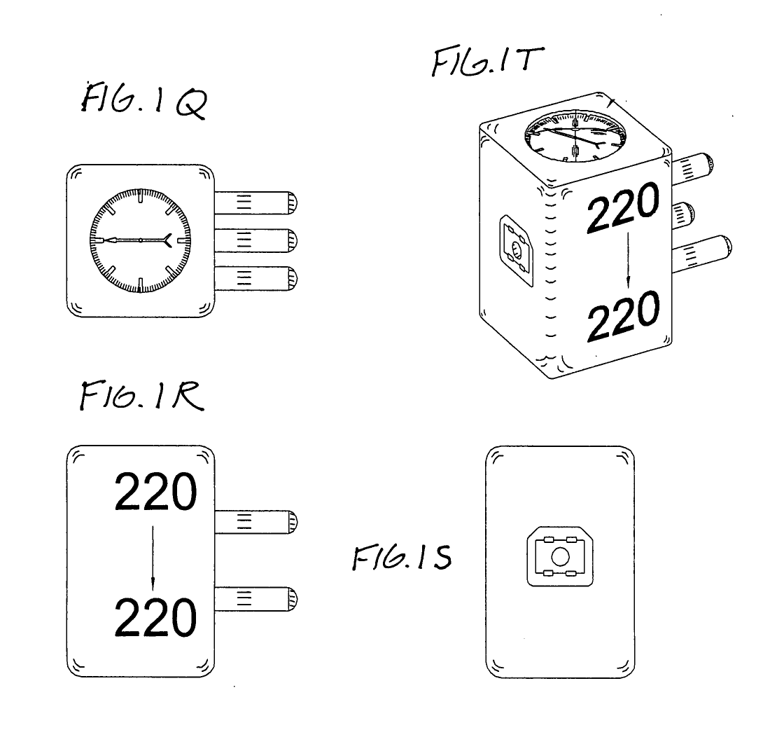

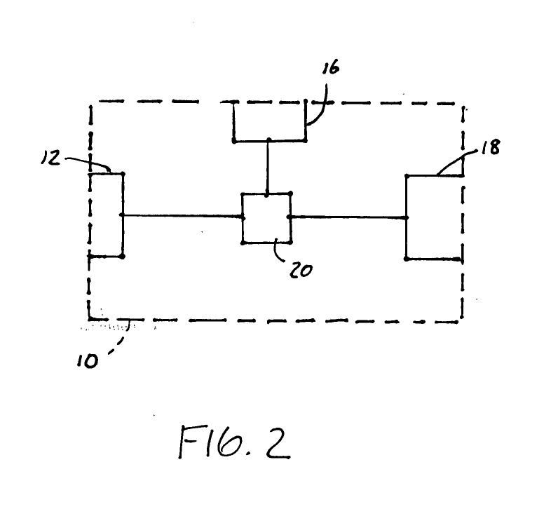

In the particular embodiment shown, the enclosure 10 is provided with an outlet 14 for accepting the plug from the battery charger or from the device incorporating a rechargeable battery (not shown). For recharging the battery of, for instance, a cordless drill or screwdriver, the outlet 14 receives the 110VAC power cable of the battery charger. If the device is, for instance, a cell phone, so-called e-Reader, or portable music or video player, the outlet 14 may be a plug for receiving the USB cable. A user-set timer 16 is provided that switches power to the outlet 14 off so that, at the conclusion of the time set on timer 16, the rechargeable device or battery charger is disconnected from the power by circuitry (see FIG. 2) contained within enclosure 10 so that battery charging stops. Those skilled in the art who have the benefit of this disclosure will recognize that timer 16 is not the only way to accomplish the goal of disconnecting the device or the charger from the power. In one embodiment (not shown), the enclosure 10 is provided with a switch that, when activated, commences a 15 minute (or 30, 45, 60, etc. minute, or other interval as selected by the user) period before power to outlet 14 is switched off so that the device or charger is disconnected from the power source by the circuitry contained within enclosure 10. In a third embodiment, or alternatively, circuitry is provided for detecting the “charged” or “charge complete” message, light, or other indicator from the charger, the battery, or the device being charged and, upon detecting that signal, switching off the power to outlet 14.

Referring now to FIG. 2 showing a schematic view of the circuitry within enclosure 10, when plug 12 is connected to a power source, the plug 18 to a battery charger (the charger not being shown in FIG. 2) is plugged into the outlet 14 of enclosure 10. When the time set on timer 16 is reached, timer 16 outputs a signal that activates the relay 20, switching off the power supplied to outlet 14.

Those skilled in the art who have the benefit of this disclosure will also recognize that certain changes can be made to the component parts of the apparatus of the present invention without changing the manner in which those parts function and/or interact to achieve their intended result. All such changes, and others that will be clear to those skilled in the art from this description of the preferred embodiment(s) of the invention, are intended to fall within the scope of the following, non-limiting claims.

What is claimed is:

1. Apparatus for interrupting the charging of either a rechargeable battery, a device including a rechargeable battery, or a charger for a rechargeable battery comprising:
a plug for connecting to a power source;
an outlet for receiving a plug from either a rechargeable battery or a charger for a rechargeable battery; and
circuitry for switching off the power to said outlet.

2. The apparatus of claim 1 additionally comprising a timer for producing a signal to said circuitry, said circuitry producing an output operable to switch the power to said outlet off upon detecting a signal from said timer.

3. A method for switching off the power provided to either a rechargeable battery, a device including a rechargeable battery, or a charger for a rechargeable battery, thereby interrupting the charging of the battery, comprising the steps of:
connecting either a rechargeable battery or a charger for a rechargeable battery to a power source;
charging the battery for a period of time sufficient to cause either the battery, the device including the battery, or the charger to produce an indicator that the battery is charged; and
detecting the indicator output by the battery, the device including the battery, or the charger and switching off the power provided to the battery, the device including the battery, or the charger.
